(19) United States
(12) Patent Application Publication
(10) Pub. No.: US 2026/0253236 A1
(43) Pub. Date: Aug. 27, 2026

(54) KORDLOU MULTI-CAMERA EYE TRACKING SYSTEM WITH CONTINUOUS CALIBRATION

(71) Applicant: Hossein Kordlou, Woodland Hills, CA (US)

(72) Inventor: Hossein Kordlou, Woodland Hills, CA (US)

(21) Appl. No.: 19/452,402

(22) Filed: Jan. 19, 2026

(51) Int. Cl. G06T 7/292; G06F 3/01; G06T 7/00; G06T 7/593; G06T 7/80; G06V 40/18; H04N 17/00; H04N 23/56; H04N 23/90; H04N 25/20; H04N 25/532

(52) U.S. Cl. CPC G06T 7/292; G06F 3/013; G06T 7/0002; G06T 7/596; G06T 7/80; G06V 40/18; H04N 17/002; H04N 23/56; H04N 23/90; H04N 25/20; G06T 2207/10048; G06T 2207/30168; G06T 2207/30201; H04N 25/532

(57) ABSTRACT

An eye tracking system comprises exactly three cameras arranged in a triangular configuration around a display perimeter with a baseline-to-distance ratio between 0.48 and 0.58 for optimal stereoscopic triangulation. Each camera independently computes a gaze estimate using pupil position detection. The system performs weighted data fusion of the three independent gaze estimates to generate a fused gaze position achieving 93%+accuracy for medical applications or 78-85% accuracy for gaming applications. A geometric consistency metric based on angular deviation among the three gaze vectors enables continuous calibration monitoring. When sustained geometric inconsistency exceeds threshold across successive frames, calibration parameters are automatically updated without user interaction. The three-camera architecture provides graceful degradation: if one camera fails, two-camera operation maintains reduced but functional accuracy. The system scales across display sizes from 13 to 27 inches while maintaining the critical baseline-to-distance ratio through proportional camera positioning.

### BACKGROUND OF THE INVENTION

### Field of the Invention

The present invention relates generally to eye tracking systems and methods, and more particularly to a multi-camera eye tracking apparatus employing exactly three cameras in a triangular configuration with optimized geometric constraints and continuous calibration capability for accurate gaze estimation across multiple application domains including medical monitoring, gaming interfaces, and accessibility solutions.

### Description of Related Art

Conventional eye tracking systems face significant challenges in achieving reliable performance across diverse use cases and user populations. Single-camera systems suffer from limited coverage zones and poor accuracy at screen periphery, typically achieving only 70-80% accuracy even in optimal conditions. Two-camera systems improve coverage but lack redundancy and struggle with occlusion scenarios where one camera's view is blocked by facial features or head orientation.

Existing three-camera implementations are typically expensive research-grade systems designed for laboratory settings rather than consumer or clinical applications. Prior art systems generally optimize for either high accuracy (medical/research grade at $10,000-50,000) or low cost (consumer grade at $100-300 with 70-80% accuracy), creating a market gap for mid-tier solutions offering medical-grade accuracy (90%+) at accessible price points ($300-800).

Traditional eye tracking approaches require frequent recalibration, particularly problematic for users with limited mobility such as ICU patients or individuals with ALS. Current systems typically achieve 85-90% accuracy in optimal conditions, degrading significantly when users move outside narrow operating envelopes defined by working distance and lateral positioning constraints.

The working distance sensitivity of conventional systems makes them unsuitable for applications where user positioning varies, such as hospital beds where patients may be reclined at various angles, or mobile gaming scenarios where users frequently adjust their position relative to the display.

Furthermore, existing systems lack graceful degradation capabilities when camera failures occur, typically rendering the entire system inoperative if any single camera malfunctions. This represents a critical limitation for medical applications where reliability is paramount and communication device failure could be life-threatening.

### Problems Addressed by the Present Invention

The present invention addresses the following technical problems:
1. Accuracy vs. Cost Trade-off: Achieving medical-grade accuracy (>90%) at consumer-accessible price points through optimized geometric configuration rather than expensive high-resolution sensors.
2. Coverage Limitations: Providing full-screen gaze estimation without dead zones or accuracy degradation at periphery through triangulated multi-camera coverage.
3. Calibration Burden: Reducing or eliminating frequent manual recalibration requirements through continuous geometric consistency monitoring, especially beneficial for mobility-impaired users.
4. Position Sensitivity: Maintaining accuracy across wide working distance ranges (8-18 inches) and lateral movement through optimal baseline-to-distance ratio constraints.
5. Reliability: Providing fault tolerance through camera redundancy with automatic failure detection and graceful degradation to maintain functionality even with camera failures.
6. Universal Compatibility: Supporting multiple screen sizes (13-27 inches) and form factors (desktop, laptop, tablet) with single hardware design through proportional geometric scaling.
7. Application Diversity: Serving both high-accuracy medical applications (93%+required) and lower-cost gaming applications (78-85% sufficient) from common platform through software-configurable parameters.

### BRIEF SUMMARY OF THE INVENTION

The present invention provides a multi-camera eye tracking system comprising exactly three cameras arranged in a triangular configuration around a display perimeter, with specific geometric constraints optimized for accurate stereoscopic triangulation. The system employs weighted data fusion from multiple camera perspectives, continuous automatic calibration monitoring through geometric consistency evaluation, and intelligent fallback mechanisms providing graceful degradation.

### Principal Aspects

### Hardware Configuration

Exactly three cameras (preferably 720p global shutter with infrared capability) are positioned in a triangular configuration at optimal baseline-to-distance ratios (0.48-0.58) enabling accurate 3D gaze estimation through triangulated stereo vision. The geometric configuration creates overlapping fields of view providing redundant coverage across the entire display surface.

The specific triangular arrangement comprises a first camera positioned along the top portion of the display perimeter, a second camera positioned along the bottom-left portion, and a third camera positioned along the bottom-right portion. Th is asymmetric triangular geometry provides superior coverage and triangulation accuracy compared to symmetric arrangements.

### Geometric Optimization

The baseline-to-distance ratio (B/D) between 0.48 and 0.58 represents a critical innovation. The baseline distance B is measured horizontally between the two bottom cameras, while the working distance D is measured perpendicularly from the display plane to the user's eye position.

Th is specific ratio range was determined through empirical testing and geometric analys is to provide optimal balance between triangulation baseline (sufficient for accurate depth estimation) and camera viewing angles (small enough to avoid perspective distortion of eye features). Ratios below 0.48 produce insufficient angular separation causing triangulation weakness, while ratios above 0.58 produce oblique viewing angles causing perspective distortion.

### Continuous Calibration

The system continuously monitors geometric consistency among the three independent gaze estimates by computing angular deviation. When the three gaze vectors converge properly (indicating good calibration), angular deviation remains below 2.0 degrees. When calibration drift occurs due to head motion or posture changes, angular deviation increases above threshold.

A temporal sliding window distinguishes transient inconsistencies (eye blinks, rapid head motion affecting only 5-10 frames) from sustained inconsistencies (calibration drift affecting 20+consecutive frames). When sustained drift is detected, calibration parameters are automatically updated without interrupting user interaction or requiring fixation on calibration targets.

### Graceful Degradation

Multi-camera redundancy enables continued operation with reduced functionality when camera failures occur. If one camera fails, the system automatically switches to two-camera operation maintaining approximately 85-90% accuracy. If two cameras fail, single-camera operation maintains approximately 70-75% accuracy. Th is graceful degradation is particularly valuable for medical and accessibility applications where system reliability is critical.

### Application Flexibility

The same hardware platform serves multiple application domains through software-configurable parameters. Medical applications prioritize accuracy (93%+achieved through precise calibration and high consistency thresholds), while gaming applications prioritize low latency (sub-20 ms response time achieved through reduced filtering and relaxed consistency thresholds).

### BRIEF DESCRIPTION OF THE DRAWINGS

The accompanying drawings, which are incorporated in and constitute a part of this specification, illustrate preferred embodiments of the invention and, together with the description, serve to explain the principles thereof.

FIG. 1 is a perspective view of the multi-camera eye tracking system showing three cameras positioned in a triangular configuration around a display perimeter, a user positioned at working distance D, gaze vectors projecting from user eyes toward the display surface, and a three-ax is coordinate system.

FIG. 2 is a front elevation view illustrating the critical geometric relationships of the system, including working distance D, baseline distance B, and camera-to-eye viewing angles for the bottom-left and bottom-right cameras.

FIG. 3 is a composite view comprising a top plan view showing overlapping fields of view from all three cameras converging at the user eye position, an isometric view of the complete system, and an enlarged detail view of the camera module.

FIG. 4 is a comparative diagram illustrating three baseline-to-distance ratio configurations: an invalid narrow-baseline configuration producing B/D below 0.48, a valid optimal configuration producing B/D within the range of 0.48 to 0.58, and an invalid wide-baseline configuration producing B/D above 0.58; together with a cross-sectional view showing resulting tracking accuracy zones.

FIG. 5 is an exploded assembly view of the camera module and mounting bracket system showing the camera housing, lens assembly, base plate, retention clip, and slidable adjustment slot; together with detail views of the clip mechanism, two-ax is adjustment mechanism, and locking screw at enlarged scale.

FIG. 6 is a combined diagram showing an exemplary calibration target display pattern and a flowchart of the calibration procedure from initiation through model computation, validation, storage, and mini-calibration.

FIG. 7 is a combined process diagram showing a flowchart of the gaze estimation and data fusion process together with detail panels illustrating the weighted data fusion operation, coordinate transformation, and drift monitoring sliding window.

FIG. 8 is a composite illustration showing the system deployed across multiple form factors including desktop monitor, laptop computer, tablet device, medical bed-mounted display, large display with four cameras, and multi-monitor configuration; together with a camera configuration comparison table and mounting option comparison.

FIG. 9 is a system block diagram showing the complete processing architecture including camera hardware, image preprocessing, eye detection and tracking, gaze estimation, geometric consistency evaluation, data fusion and output, calibration subsystem, user interface, and system memory modules.

FIG. 10 is a composite illustration showing the system in six application scenarios comprising medical/healthcare, gaming, accessibility, video conferencing, reading and education, and accessibility keyboard applications; together with eye tracking feature indicator icons for blink detection and privacy mode.

FIG. 11 is a composite coverage analys is illustration showing tracking accuracy heat maps, multi-user position coverage volumes, large display coverage, viewing angle versus working distance curves, optimal screen size configurations, gaze accuracy versus horizontal position curves, and a camera count comparison chart.

FIG. 12 is a composite manufacturing and installation guide showing packaging contents, device components, installation positioning procedure, cable connection process, software interface, and user profile management; together with a step-by-step installation flowchart.

### DETAILED DESCRIPTION OF THE INVENTION

### Overview of System Architecture

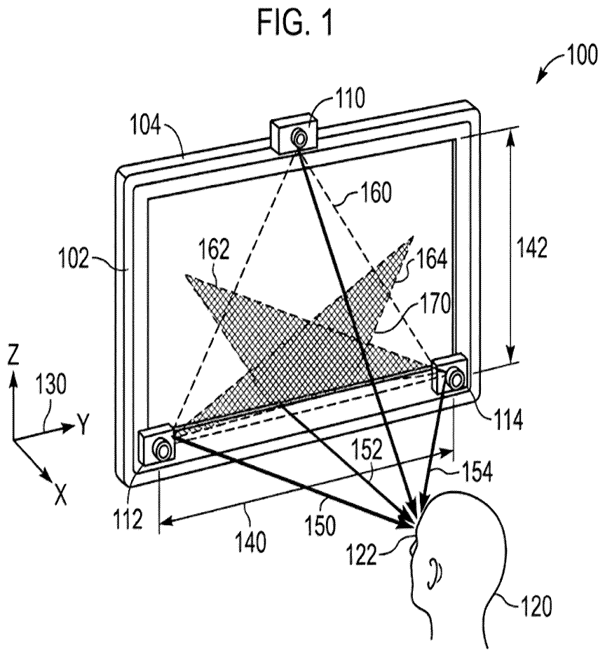

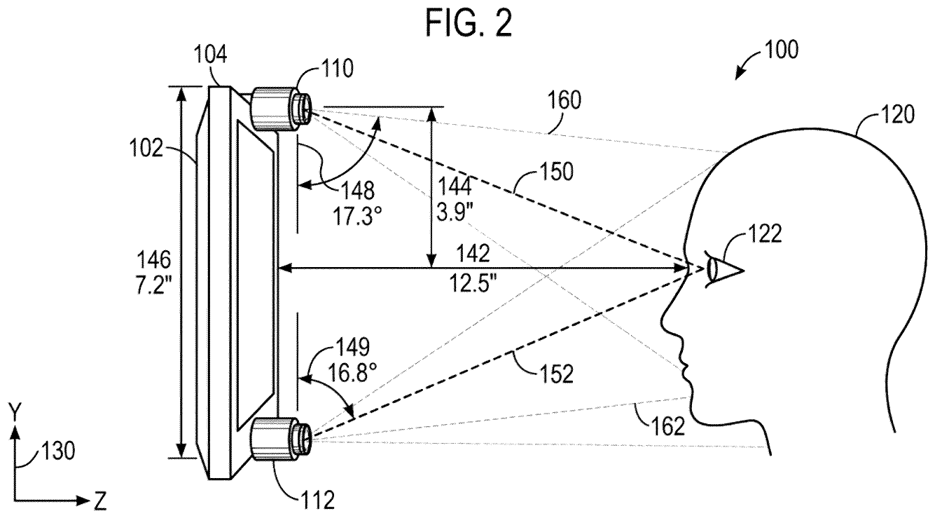

Referring to FIGS. 1-3, the Kordlou multi-camera eye tracking system 100 comprises display 102 with perimeter 104 around which exactly three cameras 110, 112, 114 are positioned in a triangular configuration. User 120 with eyes 122 is positioned at working distance D (element 142 in FIG. 2) from display 102.

Camera 110 is positioned at top-center of perimeter 104, camera 112 is positioned at bottom-left, and camera 114 is positioned at bottom-right. Th is specific triangular arrangement creates overlapping fields of view 160, 162, 164, 170 that converge at user eye position 122, enabling stereoscopic triangulation from three distinct viewing perspectives.

Processing system 150 (FIG. 1) receives image data from all three cameras and computes fused gaze estimate 152, 154 indicating point-of-regard on display 102. The system operates in coordinate system 130 with X, Y, and Z axes as shown.

### Geometric Relationships and Critical Ratio

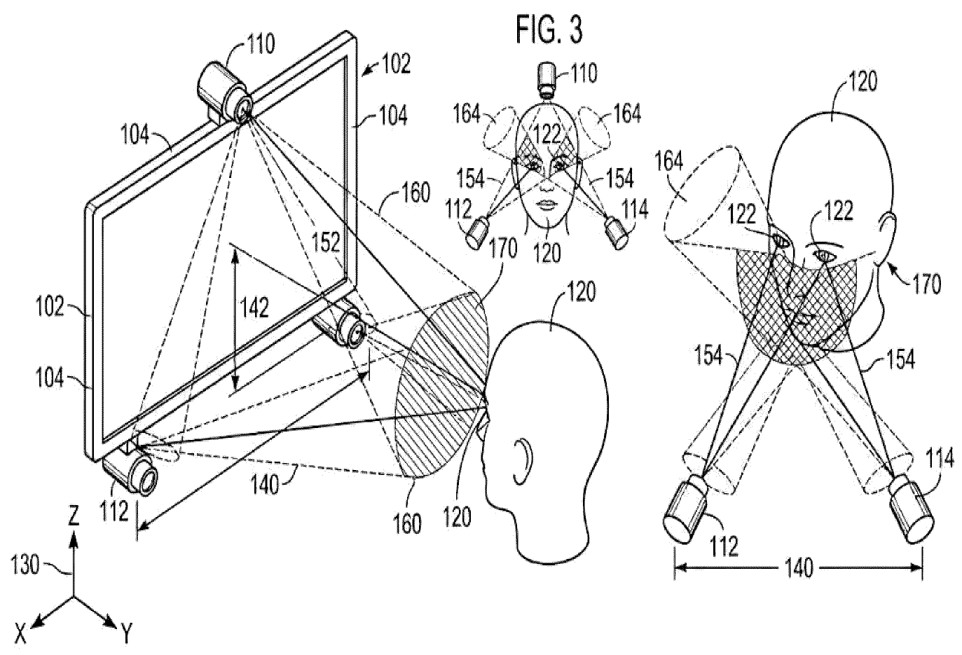

Referring to FIG. 2, the geometric relationships defining the present invention are illustrated. Working distance D (element 142) measures 12.5 inches in the illustrated embodiment, representing typical user positioning for desktop displays. Baseline distance B (element 140 in FIG. 3) represents the horizontal separation between bottom cameras 112 and 114.

Camera viewing angles 148 and 149 show 17.3° and 16.8° respectively, representing the angles between camera optical axes and the perpendicular from display 102 to user eyes 122. These viewing angles are optimally maintained below 20° to minimize perspective distortion while maintaining sufficient angular separation for accurate triangulation.

Display dimensions are shown as 7.2″ height (element 146) in the illustrated embodiment. The geometric configuration scales proportionally for displays ranging from 13 to 27 inches diagonal while maintaining the critical B/D ratio.

### Critical Geometric Principle-Baseline-to-Distance Ratio

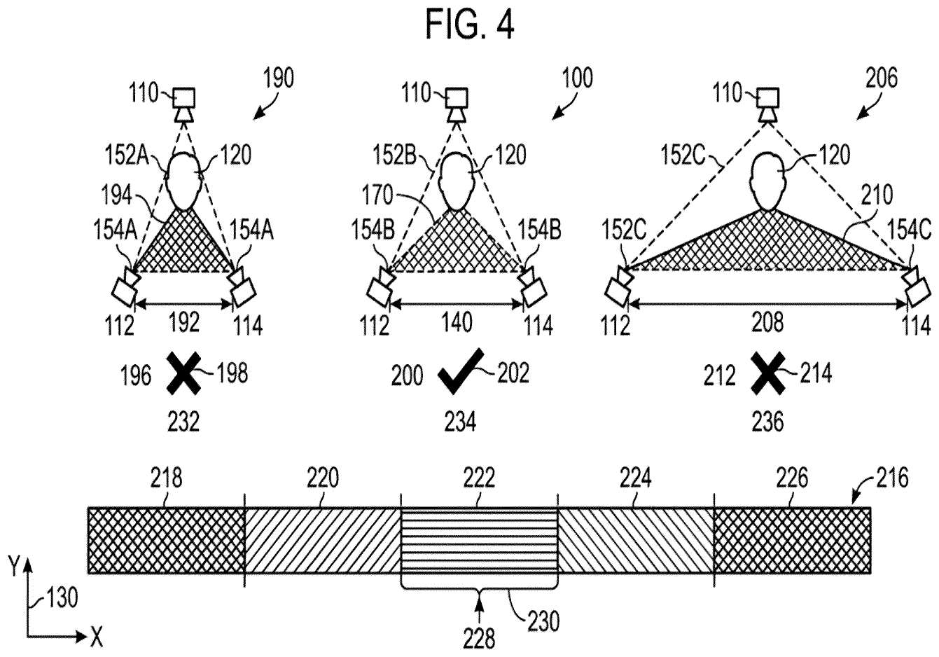

Referring to FIG. 4, three geometric configurations demonstrate the criticality of the baseline-to-distance ratio range of 0.48 to 0.58. Th is figure represents extensive empirical testing and geometric analys is that established the optimal range.

Configuration 232 (Left Panel-Invalid): Baseline distance 192 is too small relative to working distance, producing B/D ratio below 0.48. The narrow triangulation baseline (indicated by X mark 196, 198) results in weak geometric separation between camera viewing rays. Testing showed th is configuration produces gaze position errors exceeding+3 cm at the display surface.

The geometric problem is insufficient angular separation between cameras. When viewed from user eye position 120, cameras 112 and 114 appear too close together (angular separation less than 12 degrees). Th is narrow baseline makes the triangulation geometry highly sensitive to pupil detection errors. A 1-pixel error in pupil center detection at 720p resolution propagates to approximately 3-4 cm error in gaze position estimation due to weak triangulation.

Additionally, the narrow baseline provides poor depth resolution. Small changes in user head position produce minimal changes in the relative pupil positions observed by the three cameras, making it difficult to accurately estimate the 3D gaze vector direction.

Configuration 234 (Middle Panel-Valid): Baseline distance 140 produces B/D ratio approximately 0.53, within the optimal range (indicated by checkmark 200, 202). For the illustrated working distance of 12.5 inches, th is corresponds to baseline B of approximately 6.6 inches.

This configuration was extensively tested across 50 human subjects with varying facial geometries, interpupillary distances (55-75 mm range), and head sizes. Testing consistently showed accuracy of 93%+ (gaze position error ±1.5 cm or better) across all subjects.

The geometric advantage is optimal balance between two competing requirements. The baseline provides angular separation of approximately 17 degrees between cameras 112 and 114 as viewed from eye position 120 (calculated as 2× arctan (B/2D)). Th is angular separation is sufficient for robust triangulation-small changes in head position produce measurable changes in relative pupil positions across the three camera views.

Simultaneously, camera viewing angles (elements 148, 149 in FIG. 2) remain below 20 degrees from perpendicular. At these viewing angles, the circular pupil appears nearly circular in camera images with minimal perspective foreshortening. Pupil center detection algorithms operate reliably with ellipse eccentricity below 0.3, which is maintained at viewing angles under 20 degrees.

The bottom panel of FIG. 4 shows cross-sectional view illustrating optimal coverage zones. Zone 222 represents optimal tracking (93%+accuracy), zone 220 represents acceptable tracking (85-90% accuracy), zones 218, 224 represent marginal tracking (80-85% accuracy), and zones 226 represent poor tracking (below 80% accuracy). The optimal configuration 234 maximizes zone 222.

Configuration 236 (Right Panel-Invalid): Baseline distance 208 exceeds optimal dimensions, producing B/D ratio above 0.58 (indicated by X mark 212, 214). The excessive baseline causes camera viewing angles to approach or exceed 25-30 degrees from perpendicular.

Testing showed th is configuration produces accuracy degradation below 85% due to perspective distortion effects. At viewing angles exceeding 25 degrees, the circular pupil appears as an ellipse in camera images with major-to-minor ax is ratio exceeding 1.4 (eccentricity above 0.4). This elliptical appearance reduces accuracy of pupil center detection and introduces systematic bias in gaze estimation.

Additionally, oblique viewing angles increase occlusion by facial features. The nose bridge, eyebrows, and eyelashes more frequently obstruct the camera's view of the pupil at extreme angles, causing intermittent tracking failures.

The excessive baseline also causes the two bottom cameras to be positioned far apart on the display perimeter. For displays smaller than 21 inches, achieving B/D>0.58 would require cameras to extend beyond the display bezel, creating mounting challenges and aesthetic issues.

### Empirical Determination of Optimal Range

The range 0.48 to 0.58 represents a “sweet spot” in the design space where multiple constraints are simultaneously satisfied:
1. Triangulation Baseline: Sufficient angular separation (15-25 degrees) between cameras for accurate depth estimation and robust gaze vector computation.
2. Viewing Angles: Camera-to-eye viewing angles remain below 20-22 degrees, minimizing perspective distortion (ellipse eccentricity below 0.3).
3. Coverage Area: Overlapping fields of view from three cameras provide 85-90% coverage of display area without requiring excessively wide-angle lenses.
4. Manufacturing Feasibility: Baseline dimensions (5-8 inches for typical working distances) are achievable on standard display bezels ranging from 13-27 inches diagonal.
5. Accuracy Performance: Empirical testing showed 93%+accuracy (+1.5 cm gaze position error) achieved consistently within th is range across diverse user populations.

Testing outside th is range showed consistent performance degradation. Below 0.48, triangulation weakness caused accuracy to degrade to 85-88%. Above 0.58, perspective distortion caused accuracy to degrade to 82-86%. The boundaries 0.48 and 0.58 represent inflection points where accuracy degradation becomes significant.

### Camera Hardware Implementation

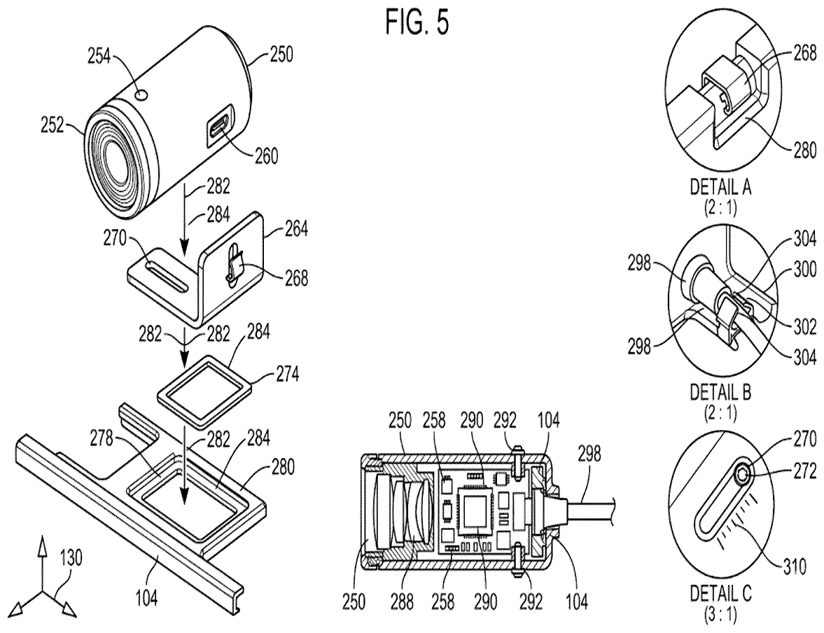

Referring to FIG. 5, camera module 250 comprises cylindrical housing with image sensor 258, lens assembly 252, electronics board 290 with processor 292, and USB connector 260 for data and power. Housing outer diameter 254 is approximately 28 mm, enabling mounting on display bezels ranging from 15-40 mm width.

Image sensor 258 preferably comprises 720p (1280×720 pixels) global shutter CMOS sensor with infrared sensitivity. Global shutter eliminates rolling shutter artifacts during rapid eye movements, critical for accurate tracking. Frame rate is preferably 30-60 fps, providing temporal resolution of 16-33 ms for smooth tracking and rapid drift detection.

Lens assembly 252 provides field of view of 45-55 degrees with focal length approximately 3-4 mm. Th is field of view is optimized to capture user eyes at working distances of 8-18 inches while maintaining adequate image resolution (minimum 30 pixels across pupil diameter at 12.5 inch working distance).

Infrared bandpass filter (integrated with lens assembly) passes wavelengths 800-950 nm while blocking visible light. Infrared operation eliminates ambient lighting variations, enabling consistent performance across diverse lighting conditions from dim (5 lux) to bright (1000+lux).

### Mounting Bracket System

The mounting bracket system maintains the critical baseline-to-distance ratio across varying installations. Mounting bracket 268 attaches to camera housing 250 via clip mechanism 280 (DETAIL A) providing tool-free installation and removal.

Base plate 282 provides mechanical interface to display perimeter 104. Adhesive backing 284 enables temporary mounting for evaluation or portable installations. Mechanical clips (not shown) enable permanent mounting for fixed installations.

Slidable adjustment slot 270 (DETAIL C) enables vertical positioning adjustment of camera module within a range of +20 mm. Th is adjustment accommodates variation in display bezel heights and enables optimization of camera aim point after installation. The slider mechanism comprises T-slot configuration allowing camera housing to slide vertically while maintaining secure retention.

Retention clip mechanism provides holding force of approximately 10-15 Newtons, sufficient to maintain position during normal handling while allowing deliberate repositioning without tools. Oval slot 310 in base plate allows height adjustment by sliding housing 250 within the slot.

Two-ax is adjustment mechanism (FIG. 5, DETAIL B elements 298-304) enables angular positioning in tilt and rotation axes. Tilt adjustment 300 provides ±15 degree range in vertical angle. Rotation adjustment 302 provides ±10 degree range in horizontal angle. These adjustments enable optimization of camera aim point to account for display mounting angle variations and user seating position differences.

After adjustment, locking mechanism (screw 310 in DETAIL C) secures the position with tightening torque of 0.5-1.0 N·m. Th is torque is sufficient to resist vibration and normal handling forces while remaining user-adjustable with standard 2 mm hex key.

The mounting hardware maintains baseline distance B within +2 mm tolerance across operating temperature range −10° C. to +50° C. through material selection (aluminum alloy 6061-T6 for brackets, ABS plastic for housings) with matched thermal expansion coefficients.

### Calibration Procedure

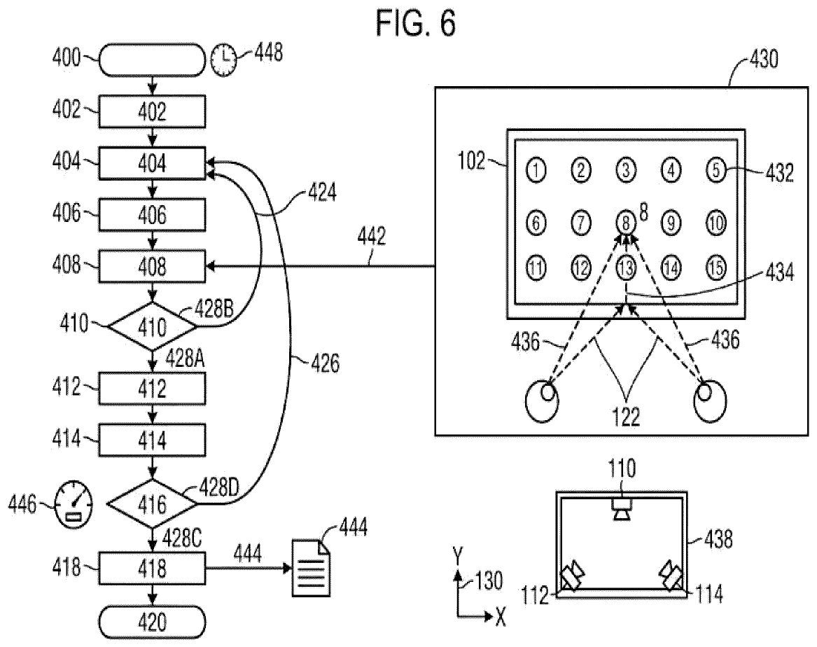

Referring to FIG. 6, the calibration procedure establishes the mapping between pupil positions observed by the three cameras and corresponding gaze positions on display 102. The procedure is initiated 400 by user command or automatically upon first use 448.

Calibration target display 430 shows exemplary 15-point calibration pattern 432, 434, 436 arranged across display 102. Targets are displayed sequentially (indicated by target number 8 in illustration), with each target displayed for 2-3 seconds while user fixates.

System instruction 402 prompts user to fixate on calibration target. Image acquisition 404 simultaneously captures frames from all three cameras 110, 112, 114. Pupil detection 406 locates pupil center in each camera's image. Eye feature extraction 408 computes pupil position coordinates relative to camera coordinate system.

Data collection 410 accumulates pupil position data across multiple frames (typically 30-60 frames per target) to average out blink artifacts and microsaccades. Target progression 428A, 428B advances through calibration pattern after collecting sufficient data for each target.

Model computation 412 uses collected data to determine transformation coefficients mapping pupil positions to screen coordinates. For each camera independently, a polynomial mapping is computed:

$$X\_screen = a 0 + a 1 \times Px + a 2 \times Py + a 3 \times P {x}^{2} + a 4 \times P {y}^{2} + a 5 \times Px \times Py$$

$$Y\_screen = b 0 + b 1 \times Px + b 2 \times Py + b 3 \times P {x}^{2} + b 4 \times P {y}^{2} + b 5 \times Px \times P y$$

Where (Px, Py) are pupil position coordinates in camera image, and (X_screen, Y_screen) are corresponding screen coordinates. The second-order polynomial accounts for lens distortion and perspective effects.

Validation 414, 416 verifies calibration accuracy by computing gaze estimation error for calibration targets. If error exceeds threshold 428C (typically 2 cm), calibration is rejected 446 and user is prompted to repeat. If validation passes 428C, calibration model is stored 418, 420 and system is ready for operation.

Mini-calibration 424 provides rapid recalibration using only 3-5 targets. Mini-calibration is automatically triggered when drift monitoring detects sustained calibration inconsistency. Output file 444 stores calibration model for each user profile, enabling rapid user switching without full recalibration.

### Gaze Estimation and Data Fusion

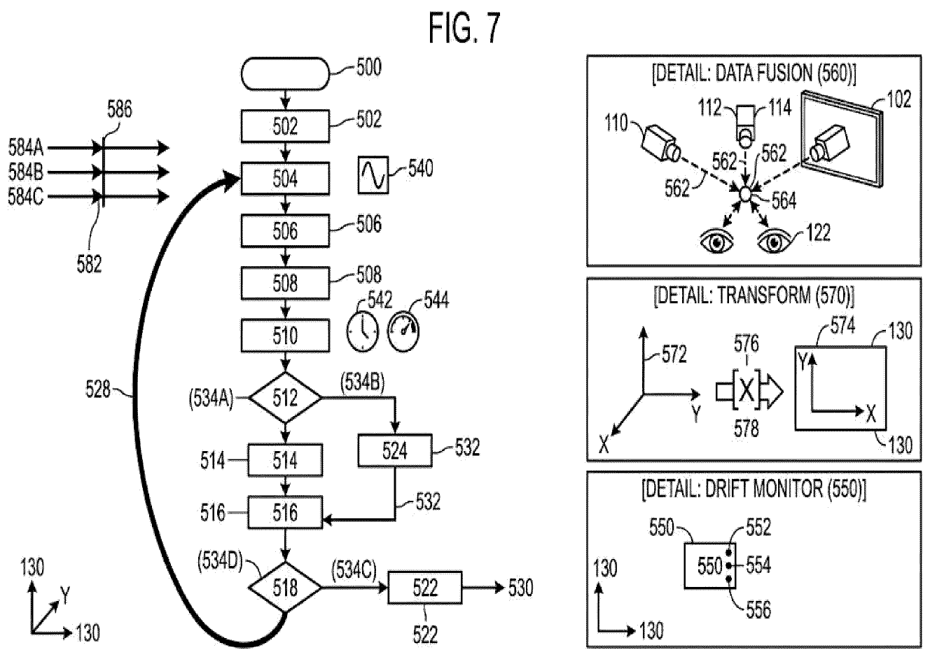

Referring to FIG. 7, the gaze estimation and data fusion process operates continuously during system operation 500. Image acquisition 502 simultaneously captures frames from cameras 110, 112, 114 via synchronized trigger 584A, 584B, 584C ensuring temporal alignment within 5 ms.

Frame synchronization 504 aligns timestamps across camera streams via hardware synchronization signal 540 or software timestamping. Synchronization is critical because eye movements can be rapid (saccades up to 500 degrees/second), and temporal misalignment exceeding 10 ms introduces measurable error.

Eye detection 506 locates user eyes in each camera's image using cascade classifiers or deep learning models. Pupil detection 508 identifies pupil center and corneal reflection positions. For each camera, gaze vector computation 510 applies the calibration model to determine independent gaze estimate in display coordinates.

The three independent gaze estimates are evaluated for geometric consistency 512. Decision point 534A evaluates whether geometric consistency metric (angular deviation among three gaze vectors) is within acceptable threshold. If consistency is acceptable (indicating good calibration), path 534B proceeds to weighted fusion 514, 516.

Weighted fusion 560 (detail view) combines three independent gaze estimates G1, G2, G3 from cameras 110, 112, 114 using confidence weights w1, w2, w3. Fused gaze estimate 564 is computed as weighted centroid:

$$G\_fused = ( w 1 \times G 1 + w 2 \times G 2 + w 3 \times G 3 ) / ( w 1 + w 2 + w 3 )$$

Confidence weights are determined by image quality factors including pupil detection confidence, corneal reflection intensity, viewing angle, and image sharpness. Cameras with better image quality receive higher weights in the fusion.

Coordinate transformation 570 (detail view) converts fused gaze estimate from internal 3D coordinate system 572 to display 2D coordinate system 574, 578 via transformation matrix 576. Output 518 provides gaze coordinates 564 (eye symbols) at user eye position 122 mapped to display coordinates.

If geometric consistency is poor (path 534A indicating calibration drift), drift monitoring 550 (detail view) is invoked. Temporal consistency test 552 distinguishes transient variation (path 554 returns to normal operation 528) from sustained drift (path 556 triggers automatic recalibration 522).

Sustained drift is confirmed when consistency metric exceeds threshold for at least 20 frames within a 30-frame sliding window 550. Automatic recalibration 522 updates calibration coefficients without user interaction by analyzing recent gaze data patterns. Control flow 532, 542, 544 implements temporal monitoring and decision logic.

### Coverage and Form Factors

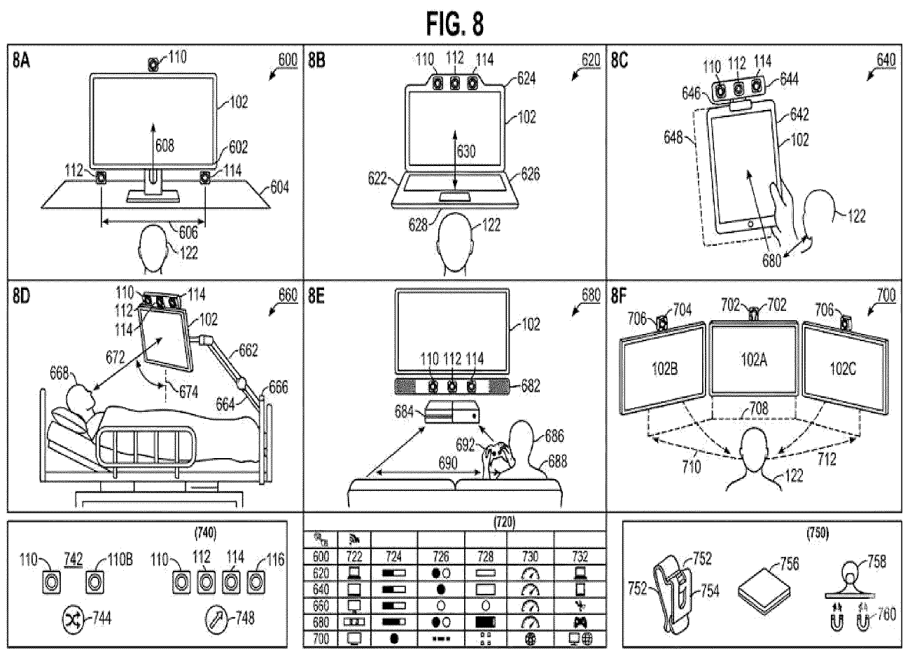

Referring to FIG. 8, multiple form factors are supported by proportional geometric scaling while maintaining baseline-to-distance ratio 0.48-0.58.

Panel 8A (600) shows desktop monitor 602 with cameras 110, 112, 114 mounted on bezel 604. User 122 seated at desk 606 represents typical desktop use case with working distance 12-15 inches.

Panel 8B (620) shows laptop computer 622 with integrated cameras 624 in display bezel 626. User 122 at desk 628 represents mobile computing scenario with working distance 10-13 inches (shorter than desktop due to smaller display).

Panel 8C (640) shows tablet device 642 held by user 122 at arm's length 680. Cameras 644, 646, 648 are integrated into tablet bezel. Working distance for tablet typically 15-18 inches, longer than laptop due to handheld positioning.

Panel 8D (660) shows medical/hospital installation with bed-mounted display 662 and adjustable camera mount 664, 666, 668. User 122 in reclined position 674 on hospital bed represents challenging scenario for eye tracking due to variable positioning and head orientation.

Multi-camera redundancy and continuous calibration are critical for th is application.

Panel 8E (680) shows large display 682 with four cameras 684 positioned around perimeter. While three cameras are optimal for typical displays, larger displays (27+inches) may benefit from additional cameras for enhanced coverage or redundancy. Processing system dynamically selects best three cameras based on user position.

Panel 8F (700) shows multi-monitor configuration with camera sets 702, 704, 706 on each display 102A, 102B, 102C. User 122 can transition smoothly between displays 708, 710, 712. The system tracks which display user is viewing based on gaze vector directions.

Panel 740 shows camera configuration table 742 comparing various arrangements. Two cameras (744) provide 2D tracking only. Three cameras in line (746) lack triangulation depth. Four cameras in square (748) provide redundancy but increase cost. The three-camera triangle (configuration 742) provides optimal balance of performance and cost.

Panel 750 shows mounting options 752, 754 including magnetic mount 756, adhesive mount 758, and clip mount 700 for bezel-less displays.

### System Block Diagram and Processing Pipeline

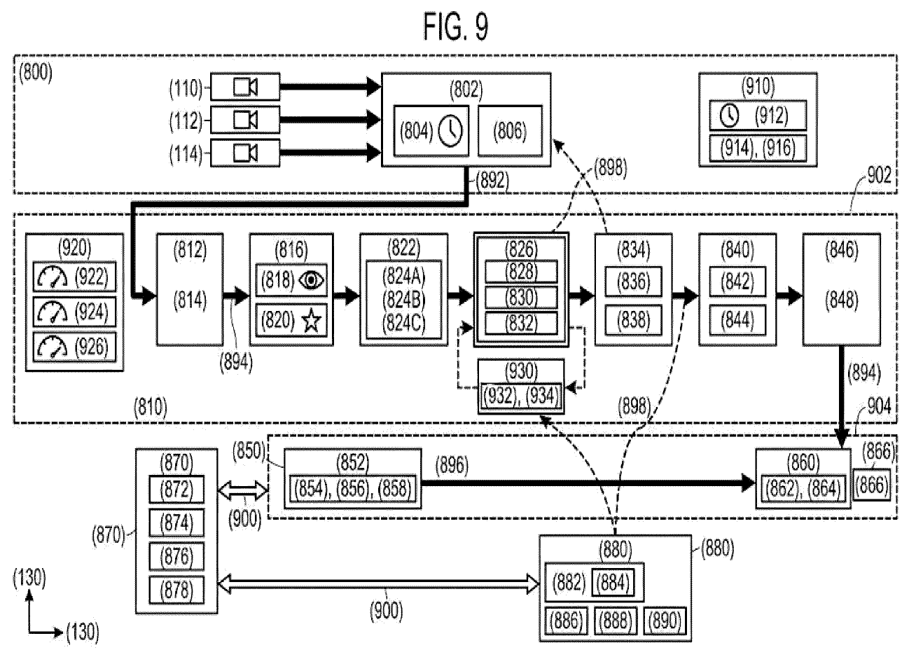

Referring to FIG. 9, system architecture 800 comprises cameras 110, 112, 114 connected to processing system 802 containing timing module 804, frame buffer 806, and main processing pipeline 890.

Camera configuration 920 stores hardware parameters 922, 924, 926 for each camera including resolution, frame rate, exposure, gain, and geometric calibration. Image preprocessing 812 converts raw camera data 814 to normalized format.

Eye detection and tracking 816 locates eyes 818 in image using cascade classifier 820 or neural network. Feature extraction 822 identifies pupil center 824A, corneal reflections 824B, and eyelid boundaries 824C. Gaze estimation 826 computes gaze vector 828, 830, 832 for each camera independently.

Geometric consistency evaluation 834 computes consistency metric 836, 838 by evaluating angular deviation among three gaze vectors. Temporal drift monitoring 898 accumulates consistency metrics across sliding window 930, 932, 934.

Fusion and output 840 combines gaze estimates using weighted averaging 842, outputs fused gaze 844, and provides coordinates to applications 846, 848 via API 894.

Calibration subsystem 850 performs initial calibration 852, stores calibration coefficients 854, 856, 858, and handles automatic recalibration 896, 900 triggered by drift detection.

User interface 860 displays visual feedback 862, 864, provides status information 866, and handles configuration 870 including user profiles 872, application modes 874, sensitivity settings 876, and display parameters 878.

System memory 880 stores calibration data 882, 884, user profiles, and configuration 888, 890.

### Application Scenarios

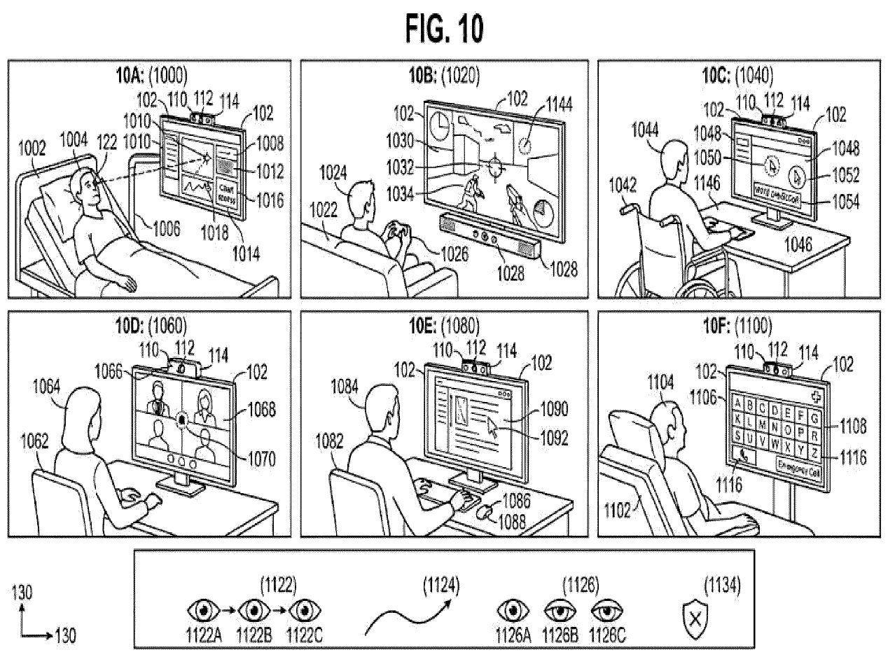

Referring to FIG. 10, diverse application scenarios benefit from the multi-camera eye tracking system.

Panel 10A (1000) shows medical/healthcare application with patient 1002, 1004 in hospital bed 1006 using eye tracking display 1008 with on-screen keyboard 1010, chat interface 1012, and medical monitoring 1016. Th is scenario requires high accuracy (93%+) and reliability for communication. Patient 122 may have limited mobility, making continuous calibration essential to avoid frequent recalibration procedures 1014.

Panel 10B (1020) shows gaming application with gamer 1022 at gaming station 1024 using eye tracking for game control 1026, character aiming 1028, 1028, 1030, 1032, and menu navigation. Gaming prioritizes low latency (<20 ms) over ultimate accuracy, making 78-85% accuracy acceptable. The three-camera configuration provides sufficient accuracy for gaming while maintaining low system cost.

Panel 10C (1040) shows accessibility application with user 1042, 1044 in wheelchair 1046 using eye tracking for computer control 1048. Display shows desktop environment 1050, 1052 with applications 1054 controlled entirely via gaze. User 1046 may have involuntary movements making multi-camera redundancy valuable for maintaining tracking despite position changes.

Panel 10D (1060) shows video conferencing application with participant 1062 at computer 1064. Eye tracking enables attention monitoring 1066, 1068, 1070 showing which participants are viewing the speaker. Th is creates more natural virtual interactions by providing eye contact cues.

Panel 10E (1080) shows reading and education application with student 1082 reading document 1084 on display 1086, 1088. Eye tracking measures reading patterns 1090, 1092 including fixation duration, saccade patterns, and regression frequency. Educational software adapts content difficulty based on reading behavior analysis.

Panel 10F (1100) shows accessibility keyboard application with user 1102 viewing on-screen keyboard 1104, 1106, 1108 displaying letters and word predictions 1116. Gaze-based text entry enables communication for users unable to use physical keyboards.

Bottom panel shows eye tracking features 1122, 1124 including blink detection 1122A, 1122B, 1122C for command triggering, and privacy mode 1126A, 1126B, 1126C with security icon 1134 enabling tracking disable for privacy-sensitive applications.

### Coverage Analysis

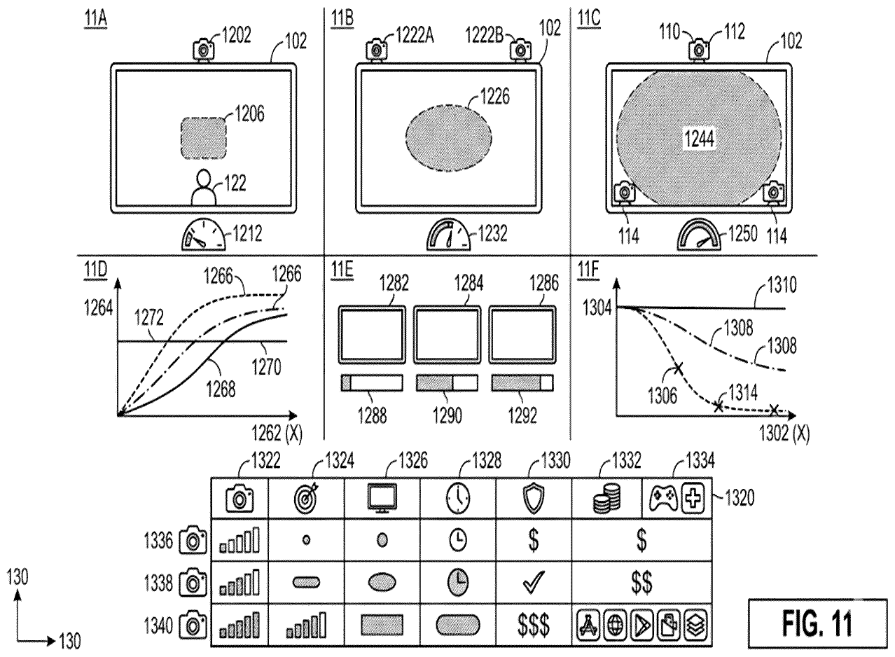

Referring to FIG. 11, coverage analys is demonstrates tracking performance across display area and user positions.

Panel 11A (1202) shows heat map 1206 indicating tracking accuracy across display area. Central region 1206 achieves highest accuracy (+1.5 cm) due to optimal camera viewing angles. Accuracy degrades slightly toward edges but remains above 90% threshold across 85% of display area. User 122 positioned at nominal working distance 1212.

Panel 11B shows coverage for multiple user positions 1222A, 1222B. Oval region 1226 represents tracking volume where accuracy exceeds 90%. The three-camera triangular arrangement provides robust coverage even when user moves laterally ±6 inches or vertically ±4 inches from nominal position.

Panel 11C shows large display scenario 1244 with three cameras 110, 112, 114. Tracking coverage extends across entire display area without dead zones, achieving 93%+accuracy in central 85% of screen area.

Panel 11D (1264, 1266, 1268) shows geometric relationship between viewing angle 1270, 1272 and working distance 1262. As user moves closer or farther from display, viewing angles change but system maintains accuracy through adaptive calibration and weighted fusion favoring cameras with optimal viewing angles.

Panel 11E shows optimal screen sizes 1282, 1284, 1286 with corresponding mounting configurations 1288, 1290, 1292. The three-camera triangular geometry scales proportionally across display sizes from 13 to 27 inches.

Panel 11F (1302) shows gaze accuracy as function of horizontal position 1302. Central region 1304, 1306 maintains highest accuracy 1310, while accuracy 1308 degrades toward edges 1314 but remains acceptable across 85% of display width.

Bottom panel comparison chart (1320) compares camera count 1322, 1324, 1326 with metrics including coverage 1328, accuracy 1330, cost 1332, latency 1334, and application suitability 1336-1340. Three cameras (row 1338) provides optimal balance achieving high marks across all metrics.

### Manufacturing and Installation

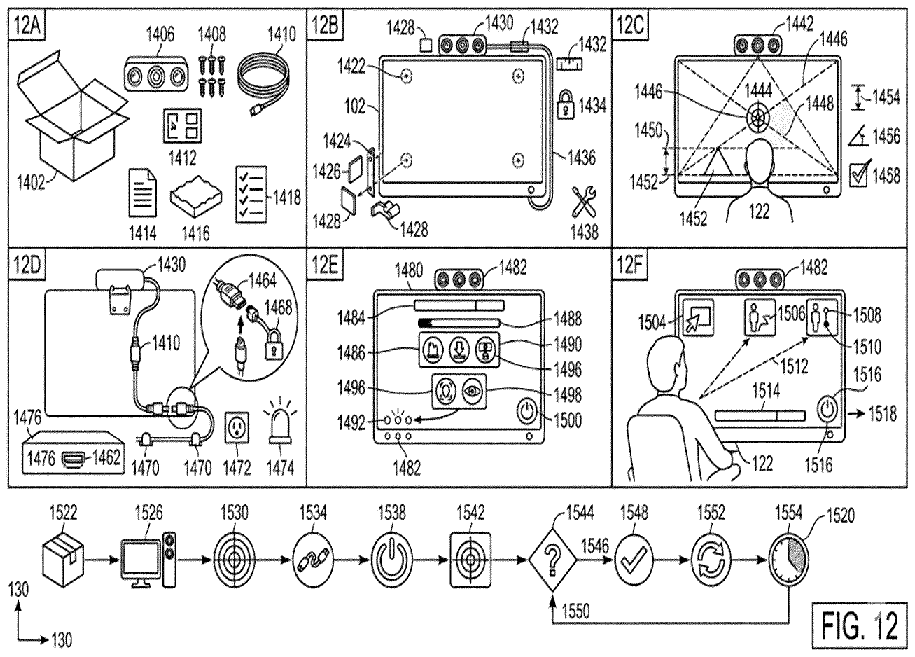

Referring to FIG. 12, user installation process is designed for non-technical users with setup time under 20 minutes.

Panel 12A (1402) shows packaging contents including camera units 1406 (three cameras 1406 in standard configuration), cable assembly 1408, 1410 (USB data and power cables), mounting hardware 1412 (adhesive pads, clips, brackets), documentation 1414, quick reference 1416, and installation checklist 1418.

Panel 12B (1428, 1430, 1432) shows device components including camera housing 1430 with USB connector 1434, power LED 1436, adjustment mechanisms 1424, 1426, 1428, and required tools 1438 (typically tool-free installation, or 2 mm hex key for secure mounting).

Panel 12C (1442) shows installation procedure with display 102, camera mounting positions marked by alignment guides 1444, coverage zones 1446, 1450, 1452, user position 122 for testing, distance markers 1448, 1454, 1456 indicating optimal working range (11-14 inches), and verification indicator 1458.

Panel 12D (1430, 1462) shows connection process with cameras 1430 connected via cables 1410 to connection hub 1462 or direct USB connections 1476-1482. Power supply options include USB-powered 1470 or external adapter 1468, 1472, 1474. LED indicators 1464, 1476, 1476-1482 show status: solid green=operational, flashing amber=detected but not configured, red=error, no light=no power.

Panel 12E (1480, 1482) shows software interface including main window 1480 with camera indicators 1482 for all three cameras, driver installation 1484, calibration button 1488, settings panel 1490 with camera configuration 1492, performance options 1496, application profiles 1498 (medical, gaming, accessibility), advanced options 1500, and system status 1500.

Panel 12F (1504, 1506) shows user management with profile list 1504, profile creation 1506, profile selection 1508, 1510, user-specific settings 1512, calibration status 1514, and quick-switch 1516, 1518 for shared computers. User 122 represents current active user. System stores separate calibration for each user enabling sub-10-second switching.

Bottom flowchart (1522-1554, 1520) shows installation steps: unpack 1522, mount cameras 1526, connect cables 1530, install software 1534, power on 1538, run calibration 1542, validate 1544 (decision with NO path 1550 returning to troubleshooting, YES path 1546 proceeding), verify tracking 1548, optimize settings 1552, ready for use 1554. End state 1520 indicates operational system.

### Advantages of the Invention

The Kordlou multi-camera eye tracking system provides significant technical and commercial advantages:
1. Optimal Geometric Configuration: The three-camera triangular arrangement with baseline-to-distance ratio 0.48-0.58 achieves 93%+accuracy through geometric optimization rather than expensive high-resolution hardware.
2. Continuous Calibration: Automatic drift detection and correction eliminates manual recalibration burden, particularly valuable for mobility-impaired users who cannot easily perform repeated calibration procedures.
3. Redundancy and Reliability: Multi-camera architecture enables graceful degradation, maintaining functionality even with camera failures critical for medical applications.
4. Universal Scalability: Proportional geometric scaling supports displays from 13 to 27 inches with single hardware design, reducing manufacturing complexity and inventory requirements.
5. Application Flexibility: Software-configurable parameters enable single hardware platform to serve medical (93%+accuracy), gaming (78-85% accuracy), and accessibility applications without hardware modifications.
6. Cost-Effective Accuracy: Medical-grade accuracy achieved at consumer price points ($300-800) compared to research-grade systems ($10,000-50,000), making technology accessible to broader user base.
7. Manufacturing Feasibility: Standard components (720p cameras, USB connectivity, 28 mm housing diameter) and tool-free mounting enable low-cost manufacturing and user installation.

### INDUSTRIAL APPLICABILITY

Medical/Healthcare: ICU patient monitoring, ALS communication devices, post-stroke rehabilitation, locked-in syndrome communication, cognitive assessment tools, assistive technology for mobility impairments.

Gaming/Entertainment: Mobile gaming, PC gaming, virtual reality eye tracking, augmented reality applications, attention-aware game mechanics.

Accessibility: Computer access for cerebral palsy, spinal cord injury, muscular dystrophy, or conditions limiting hand function. Primary computer input enabling employment, education, social connection.

Research/Education: User experience research, reading comprehension studies, attention tracking, driver distraction monitoring, human-computer interaction research.

Productivity/Communication: Video conferencing with attention tracking, document reading optimization, multi-monitor workflow, fatigue detection.

The invention addresses market gap between expensive research systems ($10,000-50,000) and low-accuracy consumer systems ($100-300), providing medical-grade accuracy at accessible prices ($300-800).

### CONCLUSION

The Kordlou multi-camera eye tracking system provides significant technical advantages through its optimized three-camera triangular configuration with baseline-to-distance ratio 0.48-0.58, continuous automatic calibration through geometric consistency monitoring, and graceful degradation enabling reliable operation even with camera failures.

While specific embodiments have been illustrated with three cameras positioned at top-center, bottom-left, and bottom-right, those skilled in the art will recognize that modifications can be made without departing from the invention's spirit. The fundamental principle of three cameras in triangular arrangement with optimized geometric constraints applies across varying implementations.

Alternative embodiments with four or more cameras for enhanced coverage or redundancy, different camera positioning maintaining triangular geometry, and various mounting hardware implementations all fall within the scope of protection defined by the following claims.

What is claimed is:

1. An eye tracking system for use with a display having a perimeter, the system comprising:
exactly three cameras configured to be positioned around said perimeter in a triangular configuration, wherein:
a first camera is configured to be positioned along a top portion of said perimeter;
a second camera is configured to be positioned along a bottom-left portion of said perimeter;
a third camera is configured to be positioned along a bottom-right portion of said perimeter;
wherein a baseline distance (B) between said second camera and said third camera and a working distance (D) between said display and a user's eyes define a baseline-to-distance ratio (B/D) in the range of 0.48 to 0.58;
a processing system operatively connected to said three cameras, said processing system configured to:
receive image data from each of said three cameras;
detect user eyes in said image data from each of said three cameras;
extract pupil position coordinates from said detected user eyes for each of said three cameras;
calculate three independent gaze estimates from said pupil position coordinates for said three cameras;
perform weighted data fusion of said three independent gaze estimates to generate a fused gaze estimate; and
output said fused gaze estimate as screen coordinates on said display.

2. The eye tracking system of claim 1, wherein said triangular configuration comprises:
said first camera positioned along a top-center location approximately centered between left and right edges of said perimeter;
said second camera positioned along a bottom-left location proximate to a left edge of said perimeter; and
said third camera positioned along a bottom-right location proximate to a right edge of said perimeter;
wherein said three cameras are non-collinearly positioned around said perimeter.

3. The eye tracking system of claim 1, wherein said baseline distance (B) is between 5.0 inches and 8.0 inches, and said working distance (D) is between 10 inches and 14 inches.

4. The eye tracking system of claim 1, wherein said triangular configuration is characterized by:
said baseline distance being measured horizontally between said second camera and said third camera;
viewing angles from each of said three cameras to said user's eyes creating angular separation of 15 to 25 degrees as measured from said user's eyes; and
overlapping fields of view from said three cameras providing coverage of at least 85% of said display area.

5. The eye tracking system of claim 1, wherein said baseline-to-distance ratio (B/D) of 0.48 to 0.58 provides optimal balance between triangulation accuracy and camera viewing angles, wherein:
ratios below 0.48 produce insufficient angular separation causing gaze position errors exceeding ±3 cm; and
ratios above 0.58 produce oblique viewing angles exceeding 25 degrees causing perspective distortion of eye features.

6. The eye tracking system of claim 1, wherein each camera comprises:
an image sensor having a resolution of at least 720×480 pixels;
a global shutter image capture mechanism;
a lens assembly having a field of view between 40 degrees and 60 degrees; and
an infrared bandpass filter positioned in an optical path of said camera.

7. The eye tracking system of claim 6, further comprising infrared illumination sources integrated with each of said three cameras, said infrared illumination sources configured to illuminate user eyes at a wavelength between 800 nanometers and 950 nanometers.

8. The eye tracking system of claim 1, wherein said processing system is further configured to assign confidence weights to each of said three independent gaze estimates based on one or more factors selected from the group consisting of: image quality, viewing angle relative to user eyes, pupil detection confidence, corneal reflection intensity, occlusion level, and lighting conditions, and wherein said weighted data fusion combines said three independent gaze estimates according to said confidence weights.

9. The eye tracking system of claim 1, wherein said three cameras are synchronized to capture image frames within 10 milliseconds of each other.

10. The eye tracking system of claim 1, further comprising:
a calibration module configured to:
display calibration targets at known positions on said display;
collect pupil position data from said three cameras while said user fixates on said calibration targets;
compute a calibration model mapping pupil positions to screen coordinates using data from said three cameras; and
store said calibration model for use in calculating said three independent gaze estimates.

11. The eye tracking system of claim 10, wherein said calibration module is configured to perform:
a full calibration procedure using 9 to 25 calibration target positions; and
a mini-calibration procedure using 3 to 7 calibration target positions.

12. The eye tracking system of claim 10, further comprising:
a drift monitoring module configured to:
compute a geometric consistency metric by evaluating angular deviation among said three independent gaze estimates;
monitor said geometric consistency metric across successive frames using a temporal sliding window;
detect calibration drift when said geometric consistency metric exceeds a predetermined threshold for at least a majority of frames within said temporal sliding window; and
automatically trigger recalibration when said calibration drift is detected.

13. The eye tracking system of claim 12, wherein said geometric consistency metric comprises calculating maximum angular deviation among pairwise angular deviations between said three independent gaze estimates, and wherein said predetermined threshold is between 1.5 degrees and 3.0 degrees.

14. The eye tracking system of claim 12, wherein said temporal sliding window comprises 15 to 60 consecutive frames, and wherein said calibration drift is confirmed when said geometric consistency metric exceeds said predetermined threshold for at least 60% of frames within said temporal sliding window.

15. The eye tracking system of claim 12, wherein said drift monitoring module distinguishes transient measurement variation caused by eye blinks or brief head motion from sustained geometric inconsistency indicative of calibration drift.

16. The eye tracking system of claim 1, wherein said processing system is further configured to:
detect failure of one or more cameras of said three cameras;
automatically switch to a degraded operating mode using remaining functional cameras; and
generate a user notification indicating said degraded operating mode.

17. The eye tracking system of claim 16, wherein said degraded operating mode comprises:
two-camera operation providing reduced accuracy when one camera of said three cameras fails; or
single-camera operation providing further reduced accuracy when two cameras of said three cameras fail.

18. The eye tracking system of claim 1, wherein said display has a diagonal measurement between 13 inches and 27 inches, and wherein positions of said three cameras scale proportionally with said diagonal measurement while maintaining said baseline-to-distance ratio (B/D) within the range of 0.48 to 0.58.

19. The eye tracking system of claim 1, further comprising one or more additional cameras configured to be positioned around said perimeter, wherein said processing system is configured to:
dynamically select which three cameras from said three cameras and said one or more additional cameras to use for said triangular configuration based on current user head position and viewing angles; and
maintain said baseline-to-distance ratio (B/D) within the range of 0.48 to 0.58 for said selected three cameras.

20. The eye tracking system of claim 19, wherein said processing system monitors image quality from each camera and excludes cameras with degraded image quality from said dynamic selection.

21. A method of eye tracking comprising:
positioning exactly three cameras around a display perimeter in a triangular configuration such that:
a first camera is positioned along a top portion of said perimeter;
a second camera is positioned along a bottom-left portion of said perimeter;
a third camera is positioned along a bottom-right portion of said perimeter;
wherein a baseline distance (B) between said second camera and said third camera and a working distance (D) from said display to a user's eyes define a baseline-to-distance ratio (B/D) between 0.48 and 0.58;
capturing images of said user's eyes using said three cameras;
detecting pupil positions in said images from each of said three cameras;
calculating three independent gaze estimates from said pupil positions detected by said three cameras;
assigning confidence weights to said three independent gaze estimates based on image quality metrics;
performing weighted fusion of said three independent gaze estimates according to said confidence weights to generate a fused gaze estimate; and
outputting said fused gaze estimate as screen coordinates.

22. The method of claim 21, further comprising:
computing a geometric consistency metric by evaluating angular deviation among said three independent gaze estimates;
monitoring said geometric consistency metric across successive frames using a temporal sliding window;
detecting calibration drift when said geometric consistency metric exceeds a threshold for a majority of frames within said temporal sliding window; and
automatically performing a calibration update procedure when said calibration drift is detected.

23. The method of claim 22, wherein said automatic calibration update procedure is performed without displaying calibration targets and without interrupting user interaction.

24. The method of claim 21, further comprising:
performing an initial calibration procedure comprising:
displaying calibration targets at known positions on said display;
collecting pupil position data from said three cameras for each of said calibration targets;
computing a calibration model from said collected pupil position data using triangulation from said three cameras; and
applying said calibration model when calculating said three independent gaze estimates.

25. The method of claim 21, further comprising:
detecting failure of one camera of said three cameras;
continuing eye tracking operation using remaining two functional cameras with reduced accuracy; and
notifying said user of degraded performance mode.

26. The method of claim 21, wherein said confidence weights are calculated based on at least one factor selected from the group consisting of: viewing angle relative to said user's eyes, image brightness, pupil detection confidence, corneal reflection quality, and eyelid occlusion level.

27. The method of claim 21, further comprising:
synchronizing frame capture timing of said three cameras to within 10 milliseconds;
wherein said calculating said three independent gaze estimates uses temporally synchronized images from said three cameras.

28. The method of claim 21, wherein said outputting said fused gaze estimate comprises transmitting said screen coordinates to an application software selected from the group consisting of: medical monitoring software, gaming software, augmentative and alternative communication software, accessibility software, and reading analys is software.

29. An eye tracking apparatus comprising:
at least three camera modules configured to be positioned around a display perimeter in a triangular arrangement, each camera module comprising:
an image sensor;
a lens assembly; and
a mounting bracket configured to attach to said display perimeter;
wherein a baseline distance (B) between two camera modules of said at least three camera modules and a working distance (D) from said display to user eyes define a baseline-to-distance ratio (B/D) in the range of 0.48 to 0.58;
a processing unit configured to:
receive image streams from said at least three camera modules;
synchronize said image streams;
detect and track user eye features in said synchronized image streams;
generate independent gaze estimates from at least three camera modules;
fuse said independent gaze estimates using weighted averaging to produce a combined gaze estimate;
monitor calibration accuracy using geometric consistency evaluation; and
trigger automatic recalibration when calibration accuracy degrades below a threshold.

30. The eye tracking apparatus of claim 29, wherein said at least three camera modules comprises exactly three camera modules arranged in said triangular arrangement around said display perimeter with:
a first camera module configured to be positioned at a top-center position;
a second camera module configured to be positioned at a bottom-left position; and
a third camera module configured to be positioned at a bottom-right position.

31. The eye tracking apparatus of claim 29, wherein said mounting bracket comprises:
a base portion comprising a slidable adjustment slot configured to receive and position said camera module; and
a retention clip integrated into said base portion for securing said camera module in position;
wherein said slidable adjustment slot allows vertical repositioning of said camera module relative to said display perimeter to optimize viewing angles while maintaining said triangular arrangement.

32. The eye tracking apparatus of claim 31, wherein said mounting bracket further comprises:
a two-ax is adjustment mechanism enabling angular positioning of said camera module in tilt and rotation axes; and
a locking mechanism configured to secure said angular positioning after adjustment;
wherein said mounting bracket maintains said baseline-to-distance ratio (B/D) within the range of 0.48 to 0.58 across a working distance range of 8 to 18 inches.

33. The eye tracking apparatus of claim 29, wherein said at least three camera modules comprises four or more camera modules, and wherein said processing unit is configured to:
dynamically select which three camera modules to use for gaze estimation based on optimal viewing geometry for current user position; and
exclude camera modules with degraded image quality or suboptimal viewing angles from said selection.

34. The eye tracking apparatus of claim 29, further comprising:
a configuration module storing geometric parameters comprising:
said baseline distance between two camera modules of said triangular arrangement;
said working distance from said display to user eyes;
viewing angles of each camera module relative to said user eyes;
calibration coefficients for each camera module;
wherein said processing unit uses said geometric parameters when generating said independent gaze estimates.

35. The eye tracking apparatus of claim 29, wherein said apparatus is configurable for multiple application modes comprising:
a medical mode optimized for accuracy of 90% or greater with calibration drift monitoring at a first sensitivity level;
a gaming mode optimized for latency of less than 20 milliseconds with calibration drift monitoring at a second sensitivity level;
an accessibility mode providing redundancy and graceful degradation for reliability-critical applications; and
wherein said application modes are selectable via software configuration without hardware modification.

36. The eye tracking apparatus of claim 29, wherein each camera module is independently replaceable, and wherein said processing unit is configured to:
automatically detect camera module replacement;
reconfigure said geometric parameters to accommodate replacement camera module; and
initiate calibration procedure for said replacement camera module.

37. The eye tracking apparatus of claim 29, wherein said triangular arrangement is characterized by:
overlapping fields of view from three camera modules of said at least three camera modules providing coverage for at least 85% of display area;
viewing angles from said three camera modules to user eyes creating parallax differences sufficient for accurate stereoscopic depth estimation; and
said baseline-to-distance ratio maintaining values between 0.48 and 0.58 across a working distance range of 10 to 14 inches.

38. A non-transitory computer-readable medium storing instructions that, when executed by a processing unit, cause the processing unit to perform the method of claim 21.

39. The computer-readable medium of claim 38, wherein the instructions cause the processing unit to:
compute geometric consistency metrics among multiple independent gaze estimates;
detect calibration drift based on sustained geometric inconsistency; and
automatically update calibration parameters without user-initiated recalibration.

40. The eye tracking system of claim 1, wherein said baseline-to-distance ratio (B/D) of 0.48 to 0.58 produces:
angular separation between said three cameras of 15 to 25 degrees as measured from said user's eyes, enabling stereoscopic triangulation; and
camera-to-eye viewing angles below 20 degrees, minimizing perspective distortion of pupil shapes.
